(19) United States
(12) Patent Application Publication
(10) Pub. No.: US 2006/0005669 A1
(43) Pub. Date: Jan. 12, 2006

(54) Fastener engaging socket

(76) Inventor: Keith Craig Herlocker SR., Albemarle, NC (US)

Correspondence Address: Raymond M. Galasso;Galasso & Associates LP, P.O. Box 26503, Austin, TX, 78755-0503, US

(21) Appl. No.: 11/136,903

(22) Filed: May 25, 2005

Related U.S. Application Data
(60) Provisional application No. 60/574,302, filed on May 25, 2004.

(51) Int. Cl. B25B 13/06

(52) U.S. Cl. 81/125; 81/121.1; 81/177.85

(57) ABSTRACT

A fastener engaging socket for use with a hand tool comprises a fastener engaging portion, a tool engaging portion and a socket retaining structure. The socket retaining structure is configured for releasably maintaining the tool engaging potion in engagement with a fastener receiving portion of the hand tool. The fastener engaging portion includes a fastener receiving cavity. Sidewall surfaces of the fastener receiving cavity are configured providing non-rotational engagement between the fastener engaging portion and a load receiving portion of a fastener. The tool engaging portion is attached to and extends from an exterior surface of the fastener engaging portion. Exterior sidewall surfaces of the tool engaging portion are configured for providing non-rotational engagement between the tool engaging portion and the fastener receiving portion of the hand tool. The socket retaining structure is attaches to a least one of the fastener engaging portion and tool engaging portion.

### CROSS REFERENCE TO RELATED APPLICATIONS

This patent application claims priority to co-pending United States Provisional Patent Application having Ser. No. 60/574,302 filed May 25, 2004 entitled “Gear Wrench Aids”, having a common applicant herewith and being incorporated herein in its entirety by reference.

### FIELD OF THE DISCLOSURE

The disclosures made herein relate generally to hand tools and, more particularly, to fastener engaging sockets for use with wrenches.

### BACKGROUND

Gear wrenches are extremely useful tools and are well known in the art. Examples of gear drive wrenches are disclosed in U.S. Pat. Nos. 6,769,329; 6,289,771; 6,070,502; 5,979,274; 5,713,251; 1,157,427; 896,607 and 864,007. They have become widely used and accepted by professional as well as amateur mechanics, especially in the field of motor vehicle repair and maintenance.

For a given size fastener head, the head of a gear wrench is larger than that of a typical non-gear wrench due to the components of the gear wrench required for facilitating ratcheting action. Thus, the relatively large size of a gear wrench head can preclude use of the gear wrench in situations where space between a fastener being turned is relatively close to an adjacent object. In such instances, it is often necessary to either re-position the adjacent object or use a different type of wrench. Examples of such other types of wrenches include a non-ratcheting wrench and a ratchet wrench with socket. This requires having additional tools available and multiple forms of ratcheting tools to provide for ratcheting wrench capability in tight spaces. Having to have all of these types of tool available is less than desirable due to the relatively expensive cost of ratcheting wrenches, sockets and gear wrenches as well as the required space for storing all of these tools.

Therefore, an attachment for gear wrenches that at least partially overcomes the shortcomings associated with use of gear wrenches in tight spaces would be useful and advantageous.

### SUMMARY OF THE DISCLOSURE

Embodiments of the present invention enable a wench of a particular size to be used for tightening or loosening a fastener of a size larger than the particular size of the wrench. More specifically, embodiments of the present invention provide for fastener receiving sockets that are specifically configured for use with a box-end of a wrench. A fastener receiving socket in accordance with the present invention is smaller in an overall width dimension than is a box-end of a gear wrench of a comparable fastener size. For example, an overall width dimension of a fastener receiving socket for a ⅝-inch hexagonal head fastener is smaller than a box-end of a gear wrench for a ⅝-inch hexagonal head fastener. Accordingly, the present invention advantageously overcomes one or more shortcomings associated with the use of gear wrenches in certain situations (e.g., use in tight spaces).

In one embodiment of the present invention, a fastener engaging socket for use with a hand tool comprises a fastener engaging portion, a tool engaging portion and a socket retaining structure. The socket retaining structure is configured for releasably maintaining the tool engaging portion in engagement with a fastener receiving portion of the hand tool. The fastener engaging portion includes a fastener receiving cavity. Sidewall surfaces of the fastener receiving cavity are configured providing non-rotational engagement between the fastener engaging portion and a load receiving portion of a fastener. The tool engaging portion is attached to and extends from an exterior surface of the fastener engaging portion. Exterior sidewall surfaces of the tool engaging portion are configured for providing non-rotational engagement between the tool engaging portion and the fastener receiving portion of the hand tool. The socket retaining structure is attached to a least one of the fastener engaging portion and tool engaging portion.

In another embodiment of the present invention, a fastener engaging socket for use with a hand tool comprises a hexagon fastener engaging portion, a tool engaging portion and a socket retaining structure configured for releasably maintaining the tool engaging portion in engagement with a fastener receiving portion of the hand tool. The hexagon fastener engaging portion includes a fastener receiving cavity. Sidewall surfaces of the fastener-receiving cavity are configured providing non-rotational engagement between the fastener engaging portion and a hexagonal-shaped load-receiving portion of a fastener. The tool engaging portion is attached to and extends from an exterior surface of the fastener engaging portion. A central axis of the tool engaging portion is substantially in-line with a central axis of the fastener engaging portion. Exterior sidewall surfaces of the tool engaging portion are configured for providing non-rotational engagement between the tool engaging portion and at least one of a socket configured for receiving a hexagonal portion of a hexagonal-shaped load receiving portion of a fastener and an end of a wrench configured for receiving a hexagonal-shaped load receiving portion of a fastener. The socket retaining structure is attached to at least one of the fastener engaging portion and the tool engaging portion.

In another embodiment of the present invention, a packaged collection of hand tools comprises a wrench and a fastener engaging socket. The wrench has a box-end configured for providing non-rotational engagement with a hexagonal-shaped load receiving portion of a fastener. The fastener engaging socket has a fastener engaging portion and a tool engaging portion attached to and extending from an exterior surface of the fastener engaging portion. The central axis of the tool engaging portion is substantially in-line with a central axis of the fastener engaging portion. The fastener engaging portion includes a fastener receiving cavity having sidewall surfaces configured providing non-rotational engagement between the fastener engaging portion and a hexagonal-shaped load receiving portion of a fastener. Exterior sidewall surfaces of the tool engaging portion are configured providing non-rotational engagement between the tool engaging portion and the box-end of the wrench.

Turning now to specific aspects of the present invention, in at least one embodiment, a central axis of the tool engaging portion is substantially in-line with a central axis of the fastener engaging portion.

In at least one embodiment of the present invention, the socket retaining structure includes at least one of a magnetic structure and a spring loaded member.

In at least one embodiment of the present invention, a magnetic insert is connected within the fastener receiving cavity to the fastener engaging portion for releasably securing a fastener within the fastener receiving cavity.

In at least one embodiment of the present invention, the socket retaining structure is integral with the magnetic insert and the socket retaining structure includes a magnetic structure extending through a wall of the fastener engaging portion.

In at least one embodiment of the present invention, the box-end includes a ratcheting socket insert therein.

In at least one embodiment of the present invention, an overall width dimension of the fastener engaging portion is the same dimension as an overall width dimension of the closed end of the wrench.

These and other objects, embodiments advantages and/or distinctions of the present invention will become readily apparent upon further review of the following specification, associated drawings and appended claims.

### BRIEF DESCRIPTION OF THE DRAWINGS

FIG. 1 is a top perspective view of a fastener engaging socket in accordance with an embodiment of the present invention.

FIG. 2 is a bottom perspective view of the fastener depicted in FIG. 1.

FIG. 3 is a cross-sectional view taken along the line 3-3 in FIG. 1.

FIG. 4 depicts a packaged collection of hand tools in accordance with the present invention.

### DETAILED DESCRIPTION OF THE DRAWING FIGURES

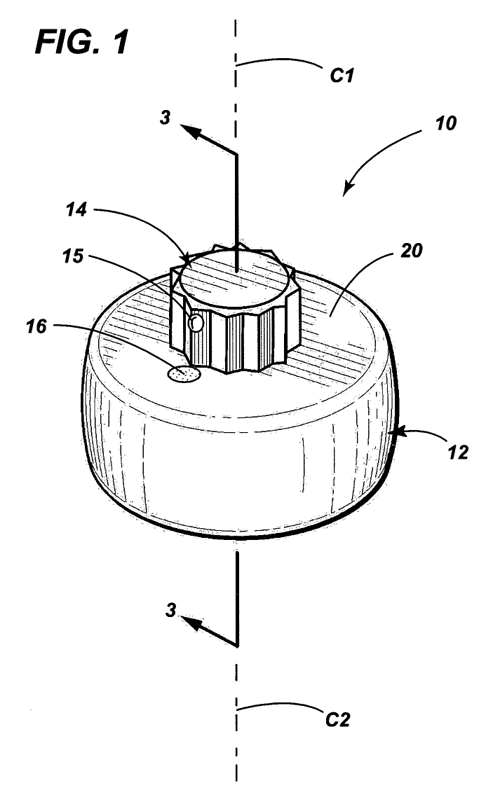

FIGS. 1-3 depict a fastener engaging socket in accordance with the present invention, which is referred to herein as the fastener engaging socket 10. The fastener engaging socket 10 is specifically configured for use with a gear wrench. However, the skilled person will appreciate that the fastener engaging socket 10 is useful with a host of other types of tools such as, for example, non-gear wrenches and ratchet wrenches.

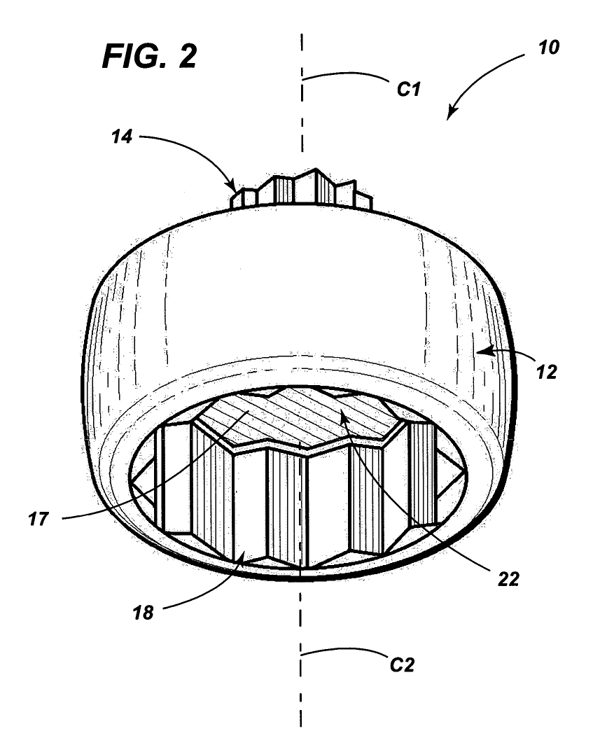

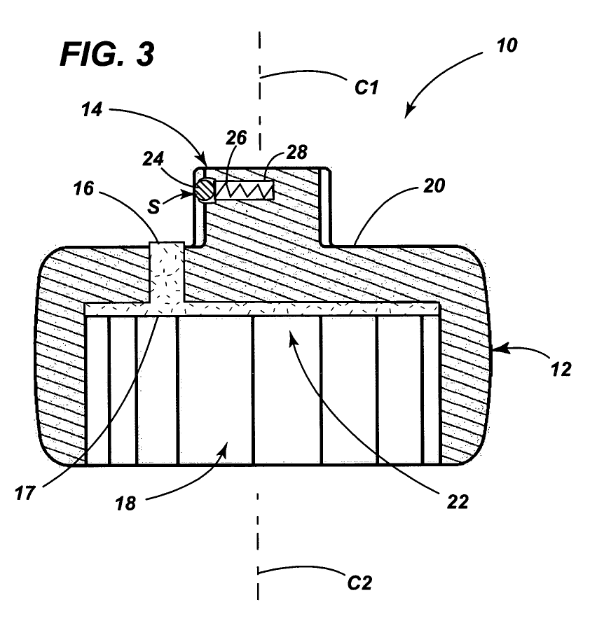

The fastener engaging socket 10 includes a fastener engaging portion 12, a tool engaging portion 14, a first socket retaining structure 15, a second socket retaining structure 16 and a magnetic insert 17. The fastener engaging portion 12 includes a fastener receiving cavity 18. Sidewall surfaces of the fastener receiving cavity 18 (i.e., interior sidewall surfaces) are configured providing non-rotational engagement between the fastener engaging portion 12 and a load receiving portion of a fastener (e.g., a head of a fastener, a nut, etc). In one embodiment (as depicted in FIGS. 2 and 3), the sidewall surfaces of the fastener receiving cavity 18 are preferably configured for engaging a hexagonal shaped fastener. In such an embodiment, the fastener receiving cavity 18 may be configured in a 6-point configuration or a 12-point configuration. A skilled person will be familiar with such configurations and, accordingly, they will not be discussed in further detail.

The tool engaging portion 14 is attached to and extends from an exterior surface 20 of the fastener engaging portion 12 at a closed end 22 (FIG. 3) of the fastener receiving cavity 18 (i.e., a bottom wall of the fastener receiving cavity 18). Sidewall surfaces of the tool engaging portion (i.e., exterior sidewall surfaces) are configured for providing non-rotational engagement between the tool engaging portion 14 and a fastener receiving portion of a tool. A socket insert of a gear wrench and a socket attachable to a ratchet wrench are examples of such a fastener receiving portion of a tool. In one embodiment (as depicted in FIGS. 1 and 2), the sidewall surfaces of the tool engaging portion 14 are preferably configured for engaging a fastener receiving portion of a tool that is itself configured for engaging a hexagonal shaped fastener. In such an embodiment, the fastener receiving portion of a tool may be configured in a 6-point configuration or a 12-point configuration.

Preferably, a central axis C1 of the tool engaging portion 14 is substantially in-line with a central axis C2 of the fastener engaging portion 12. Thus, in the preferred instance where the fastener engaging portion 12 and the tool engaging portion 14 are radially uniform (i.e., circumscribed by circular paths), the fastener engaging portion 12 and the tool engaging portion 14 exhibit concentric rotational paths.

The socket retaining structures (15, 16) are each configured for releasably maintaining the tool engaging portion 14 in engagement with the fastener receiving portion of a tool. Such functionality is preferred in that it precludes unintentional and undesirable separation of the fastener engaging socket 10 from the fastener receiving portion of a tool. As depicted, the first socket retaining structure 15 is attached to (i.e., built-into) the tool engaging portion 14 and the second socket retaining structure 15 is attached to (i.e., built into) the fastener engaging portion 12.

The first socket retaining structure 15 includes a contact member 24 (e.g., a ball) biased to a static position S by a spring 26. The contact member 24 and the spring 26 reside in a cavity 28 extending through the side surface of the tool engaging portion 14. The contact member 24 is moved from the static position S to a retracted position (not specifically shown) in response to the tool engaging portion 14 being engaged with and/or disengaged from the fastener receiving portion of a tool. For example, in use, the fastener receiving portion of the tool includes a detent that is configured for mating with the contact member 24 of the first socket retaining structure 15. When the tool engaging portion 14 is engaged with the fastener receiving portion of a tool, the contact member 24 is moved from the static position S to a retracted position. Upon the tool engaging portion 14 being engaged to a sufficient depth within the fastener receiving portion of the tool, the contact member 24 is moved back toward the static position S with the contact member 24 being engaged within the detent. Upon sufficient force being applied to the fastener engaging socket 10 for separating the tool engaging portion 14 from the fastener receiving portion of the tool, the contact member 24 is moved to the retracted position, thereby enabling the tool engaging portion 14 to be separated from the fastener receiving portion of the tool.

The second socket retaining structure provides alternate means for releasably maintaining the tool engaging portion 14 in engagement with a fastener receiving portion of a tool. For example, the second socket retaining structure is preferably configured for releasably maintaining the tool engaging portion 14 in engagement with a fastener receiving portion of a tool in situations where the fastener receiving portion of a tool is not suitably configured for being engaged by the first socket retaining structure 15 (e.g., does not include a detent). In one embodiment, the second socket retaining structure 16 includes a magnetic structure (i.e., a permanent magnet) that is exposed at the exterior surface 20 of the fastener engaging portion 12 at the closed end 22 (FIG. 3) of the fastener receiving cavity 18. In such an embodiment, when the tool engaging portion 14 is sufficiently engaged with the fastener receiving portion of a tool, the magnetic structure is magnetically attracted to an adjacent magnet attracting portion the tool (e.g., a socket insert of a gear wrench), thus releasably maintaining the tool engaging portion 14 in engagement with a fastener receiving portion of a tool.

It is disclosed herein that a fastener engaging socket in accordance with the present invention may include only one type of socket retaining structure or multiple types of socket retaining structures. Thus, a fastener engaging socket in accordance with the present invention may include a socket retaining structure that is of a magnetic structure, a socket retaining structure that includes a spring loaded member, or both. In view of the disclosures made herein with respect to socket retaining structure, a skilled person will undoubtedly recognize other configurations of socket retaining structures that may be suitably implemented in accordance with the present invention.

The magnetic insert 17 is connected within the fastener receiving cavity 18 at the closed end 22 of the fastener engaging portion 12. The magnetic insert 17 serves the function of releasably securing a fastener within the fastener receiving cavity 18. The magnetic insert 17 may be held in place by magnetic attraction to the fastener engaging socket 10 and/or by physical engagement. In one embodiment, such physical engagement is preferably facilitated through the second socket retaining structure 16 being a magnetic structure that is integral with the magnetic insert 17. For example, as depicted in FIGS. 1 and 3, the second socket retaining structure 16 is a magnetic post that is integral with the magnetic insert 17 and that extends through a respective passage in the closed end 22 of the fastener engaging portion 12.

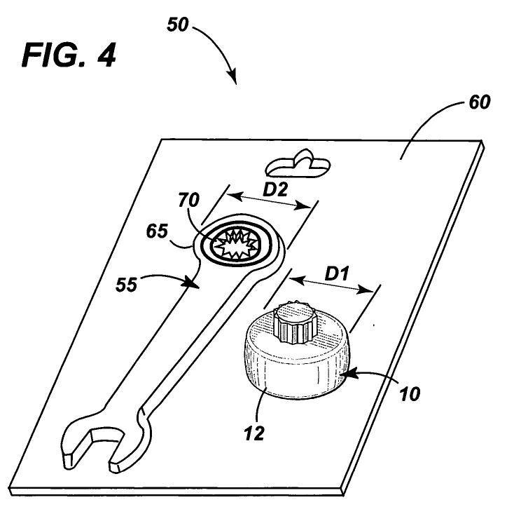

FIG. 4 depicts a packaged collection of hand tools in accordance with the present invention, which is referred to herein as the packaged tool collection 50. The packaged tool collection 50 comprises a gear wrench 55, the fastener engaging socket 10 discussed above in reference to FIGS. 1-3 and a package 60. The gear wrench 55 and the fastener engaging socket 10 are secured to the package 60 one or more conventional packaging means. Examples of such conventional packaging means include, but are not limited to, shrink wrapping, blister packing, zip tying, and adhesive mounting.

The gear wrench 55 includes a box-end 65 configured for providing non-rotational engagement with a hexagonal-shaped load receiving portion of a fastener. The box-end 65 includes a ratcheting socket insert 70 for enabling a fastener to be turned by ratcheting the gear wrench 55. The fastener engaging portion 12 of the fastener engaging socket 10 has an overall width dimension D1 equal to or greater than an overall width dimension D2 of the box-end of the wrench. A skilled person will recognize that the fastener engaging portion 12 of the fastener engaging socket 10 may be sized to accept a fastener (e.g., a head of a hex head) that is larger than that which may be accepted by the box-end 65 of the gear wrench.

The socket insert 70 of the gear wrench and associated ratcheting components occupy finite space and, thus, increase the minimum overall width diameter for a given size socket insert 70. In this manner, a fastener engaging socket in accordance with the present invention advantageously offers the potential for a fastener in a too tight a space to be manipulated (e.g., tightened or loosened) with a proper size gear wrench to be manipulated with a smaller size gear wrench in combination with a corresponding size fastener engaging socket. Additionally, a relatively small gear wrench provides for more ratcheting action in a given amount of space further adding to the advantageous impact of the present invention.

The gear wrench 55 is one example of a tool that may be packaged with the fastener engaging socket 10. Other examples include a non-gear wrench, a socket and ratchet. Additionally, the packaged tool collection 50 may include additional tools such as, for example, one or more other wrenches and one or more other fastener engaging socket.

It is disclosed herein that fastener engaging sockets in accordance with the present invention may be made in a number of different size configurations. For example, they may be made with different size tool engaging portions. Examples of the sizes for the tool engaging portions are sizes corresponding to ⅜-inch hex head fastener, ½-inch hex head fastener and 9/16-inch hex head fastener. Preferably, the size of the tool engaging portion is proportional to a size fastener that a corresponding fastener engaging socket is intended to manipulate (i.e., enables a suitable degree of torque to be applied) while not resulting in a mating gear wrench having an overall diameter that is larger than that of a mating fastener engaging socket.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A fastener engaging socket for use with a hand tool, comprising:
a fastener engaging portion including a fastener receiving cavity, wherein sidewall surfaces of the fastener receiving cavity are configured providing non-rotational engagement between the fastener engaging portion and a load receiving portion of a fastener;
a tool engaging portion attached to and extending from an exterior surface of the fastener engaging portion, wherein exterior sidewall surfaces of the tool engaging portion are configured for providing non-rotational engagement between the tool engaging portion and a fastener receiving portion of a tool; and
a socket retaining structure configured for releasably maintaining the tool engaging portion in engagement with the fastener receiving portion of a tool, wherein the socket retaining structure is attached to a least one of the fastener engaging portion and tool engaging portion.

2. The socket of claim 1 wherein a central axis of the tool engaging portion is substantially in-line with a central axis of the fastener engaging portion.

3. The socket of claim 1 wherein the socket retaining structure includes at least one of a magnetic structure and a spring loaded member.

4. The socket of claim 1, further comprising:
a magnetic insert connected within the fastener receiving cavity to the fastener engaging portion for releasably securing a fastener within the fastener receiving cavity.

5. The socket of claim 4 wherein:
the socket retaining structure is integral with the magnetic insert; and
the socket retaining structure includes a magnetic structure extending through a wall of the fastener engaging portion.

6. The socket of claim 1, further comprising:
a magnetic insert connected within the fastener receiving cavity to the fastener engaging portion for releasably securing a fastener within the fastener receiving cavity;
wherein the socket retaining structure is integral with the magnetic insert;
wherein the socket retaining structure includes a magnetic structure extending through a wall of the fastener engaging portion; and
wherein a central axis of the tool engaging portion is substantially in-line with a central axis of the fastener engaging portion.

7. A fastener engaging socket for use with a hand tool, comprising:
a hexagon fastener engaging portion including a fastener receiving cavity, wherein sidewall surfaces of the fastener-receiving cavity are configured providing non-rotational engagement between the fastener engaging portion and a hexagonal-shaped load-receiving portion of a fastener;
a tool engaging portion attached to and extending from an exterior surface of the fastener engaging portion, wherein a central axis of the tool engaging portion is substantially in-line with a central axis of the fastener engaging portion, wherein exterior sidewall surfaces of the tool engaging portion are configured for providing non-rotational engagement between the tool engaging portion and at least one of a socket configured for receiving a hexagonal portion of a hexagonal-shaped load receiving portion of a fastener and an end of a wrench configured for receiving a hexagonal-shaped load receiving portion of a fastener; and
a socket retaining structure configured for releasably maintaining the tool engaging portion in engagement with the fastener receiving portion of a tool, wherein the socket retaining structure is attached to at least one of the fastener engaging portion and the tool engaging portion.

8. The socket of claim 7 wherein the socket retaining structure includes at least one of a magnetic structure and a spring loaded member.

9. The socket of claim 7, further comprising:
a magnetic insert connected within the fastener receiving cavity to the fastener engaging portion for releasably securing a fastener within the fastener receiving cavity.

10. The socket of claim 9 wherein:
the socket retaining structure is integral with the magnetic insert; and
the socket retaining structure includes a magnetic structure extending through a wall of the fastener engaging portion.

11. The socket of claim 7, further comprising:
a magnetic insert connected within the fastener receiving cavity to the fastener engaging portion for releasably securing a fastener within the fastener receiving cavity;
wherein the socket retaining structure is integral with the magnetic insert;
wherein the socket retaining structure includes a magnetic structure extending through a wall of the fastener engaging portion; and
wherein a central axis of the tool engaging portion is substantially in-line with a central axis of the fastener engaging portion.

12. A packaged collection of hand tools, comprising:
a wrench having a box-end configured for providing non-rotational engagement with a hexagonal-shaped load receiving portion of a fastener, wherein the box-end includes a ratcheting socket insert therein for enabling a fastener to be turned by ratcheting the wrench; and
a fastener engaging socket having a fastener engaging portion and a tool engaging portion attached to and extending from an exterior surface of the fastener engaging portion, wherein a central axis of the tool engaging portion is substantially in-line with a central axis of the fastener engaging portion; wherein the fastener engaging portion includes a fastener receiving cavity having sidewall surfaces configured providing non-rotational engagement between the fastener engaging portion and a hexagonal-shaped load receiving portion of a fastener, wherein exterior sidewall surfaces of the tool engaging portion are configured providing non-rotational engagement between the tool engaging portion and the box-end of the wrench and wherein an overall width dimension of the fastener engaging portion is the same dimension as an overall width dimension of the box-end of the wrench.

13. The packaged collection of claim 12 wherein:
the fastener engaging socket further includes a socket retaining structure configured for releasably maintaining the tool engaging portion in engagement with the ratcheting socket insert; and
the socket retaining structure is attached to at least one of the fastener engaging portion and tool engaging portion.

14. The packaged collection of claim 13 wherein the socket retaining structure includes at least one of a magnetic structure and a spring loaded member.

15. The packaged collection of claim 13 wherein the fastener engaging socket further includes a magnetic insert connected within the fastener receiving cavity to the fastener engaging portion for releasably securing a fastener within the fastener receiving cavity.

16. The packaged collection of claim 15 wherein:
the socket retaining structure is integral with the magnetic insert; and
the socket retaining structure includes a magnetic structure extending through a wall of the fastener engaging portion.

17. The packaged collection of claim 12 wherein:
the fastener engaging portion includes a magnetic insert connected within the fastener receiving cavity to the fastener engaging portion for releasably securing a fastener within the fastener receiving cavity;
the fastener engaging socket includes a socket retaining structure configured for releasably maintaining the tool engaging portion in engagement with the ratcheting socket insert; and
the socket retaining structure is attached to at least one of the fastener engaging portion and tool engaging portion.

18. The packaged collection of claim 17 wherein:
the socket retaining structure is integral with the magnetic insert; and
the socket retaining structure includes a magnetic structure extending through a wall of the fastener engaging portion.
